(19) United States
(12) Patent Application Publication
(10) Pub. No.: US 2023/0039101 A1
(43) Pub. Date: Feb. 9, 2023

(54) SYSTEM AND METHODOLOGY THAT FACILITATES AN ALARM WITH A DYNAMIC ALERT AND MITIGATION RESPONSE

(71) Applicant: Lawrence Garcia, Fresno, CA (US)

(72) Inventor: Lawrence Garcia, Fresno, CA (US)

(21) Appl. No.: 17/867,586

(22) Filed: Jul. 18, 2022

Related U.S. Application Data
(60) Provisional application No. 63/222,918, filed on Jul. 16, 2021.

(51) Int. Cl. G08B 6/00; G08B 19/00; F24F 11/56; F24F 11/00; H04N 7/18

(52) U.S. Cl. CPC G08B 6/00; G08B 19/005; F24F 11/56; F24F 11/0001; H04N 7/185

(57) ABSTRACT

An alarm system includes a monitoring component configured to detect a danger in a dwelling, and an alert component that includes an array of vibration devices placed throughout the dwelling. Each of the array of vibration devices are configured to provide a tactile alert in response to a detection of the danger in the dwelling. In another aspect, an alarm system includes a monitoring component configured to detect a ventilation-related danger in a building, and a mitigation component configured to open at least one of a door or a window in the building automatically in response to a detection of the ventilation-related danger. In a further aspect, a method includes monitoring a building for a ventilation-related danger, and opening at least one of a door or a window in the building automatically in response to a detection of the ventilation-related danger.

### CROSS-REFERENCE TO RELATED APPLICATIONS

This application claims the benefit of U.S. Provisional Patent Application Ser. No. 63/222,918, filed Jul. 16, 2021, which is titled “SYSTEM AND METHODOLOGY THAT FACILITATES AN ALARM WITH A DYNAMIC ALERT AND MITIGATION RESPONSE” and its entire contents of which are incorporated herein by reference.

### TECHNICAL FIELD

The subject disclosure generally relates to alarm systems, and more specifically to a system and methodology that facilitates an alarm with a dynamic alert and mitigation response.

### BACKGROUND

Residential alarm systems have been used for several years to help home owners feel safe. For instance, conventional alarm systems typically use a siren to alert people of potential danger. For people with difficulty hearing, however, such as the deaf and the elderly, a siren might not provide an adequate warning. Conventional alarm systems also do very little to mitigate the threat that triggered the alarm. During a fire, for example, although conventional alarm systems may alert the fire department, the fire may spread rapidly before fire fighters actually arrive to the scene.

Accordingly, it would be desirable to provide a system and method which overcomes these limitations. To this end, it should be noted that the above-described deficiencies are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure, various non-limiting aspects are described in connection with facilitating an alarm with a dynamic alert and mitigation response. In one such aspect, an alarm system is provided, which includes a monitoring component configured to detect a danger in a dwelling, and an alert component that includes an array of vibration devices placed throughout the dwelling. Within such embodiment, each of the array of vibration devices are configured to provide a tactile alert in response to a detection of the danger in the dwelling.

In a further aspect, another alarm system is provided, which includes a monitoring component and a mitigation component. Here, the monitoring component is configured to detect a ventilation-related danger in a building, whereas the mitigation component is configured to open at least one of a door or a window in the building automatically in response to a detection of the ventilation-related danger.

In yet another aspect, a method is provided, which includes monitoring a building for a ventilation-related danger. The method further includes opening at least one of a door or a window in the building automatically in response to a detection of the ventilation-related danger.

Other embodiments and various non-limiting examples, scenarios and implementations are described in more detail below.

### BRIEF DESCRIPTION OF THE DRAWINGS

Various non-limiting embodiments are further described with reference to the accompanying drawings in which:

FIG. 1 illustrates an exemplary environment that facilitates an alarm system response in accordance with an aspect of the subject specification;

FIG. 2 is a block diagram illustrating exemplary response devices coupled to an alarm system in accordance with an aspect of the subject specification;

FIG. 3 illustrates an exemplary vibration disc in accordance with an aspect of the subject specification;

FIG. 4 illustrates a home equipped with an exemplary array of vibration discs in accordance with an aspect of the subject specification;

FIG. 5 illustrates a home equipped with an exemplary array of powered windows in accordance with an aspect of the subject specification;

FIG. 6 illustrates a block diagram of an exemplary alarm system that facilitates implementing aspects disclosed herein;

FIG. 7 is a first flow diagram of an exemplary methodology that facilitates an alarm system response in accordance with an aspect of the subject specification;

FIG. 8 is a second flow diagram of an exemplary methodology that facilitates an alarm system response in accordance with an aspect of the subject specification;

FIG. 9 is a block diagram representing exemplary non-limiting networked environments in which various embodiments described herein can be implemented; and

FIG. 10 is a block diagram representing an exemplary non-limiting computing system or operating environment in which one or more aspects of various embodiments described herein can be implemented.

### DETAILED DESCRIPTION

### Overview

As discussed in the background, it is desirable to provide a system and method which overcomes the various limitations of conventional alarm systems. The embodiments disclosed herein are directed towards overcoming such limitations by providing a system and methodology that facilitates an alarm with a dynamic alert and mitigation response. For instance, in a particular embodiment, an alarm system disclosed herein alerts homeowners via an array of discs placed throughout a house (e.g., under a couch, bed, etc.), wherein the discs are configured to vibrate when the alarm detects a threat (e.g., a burglary, fire, etc.). In another embodiment, an alarm system disclosed herein includes an array of devices configured to proactively mitigate a detected threat (e.g., by automatically opening windows/doors during a fire to provide ventilation).

### Exemplary Embodiments

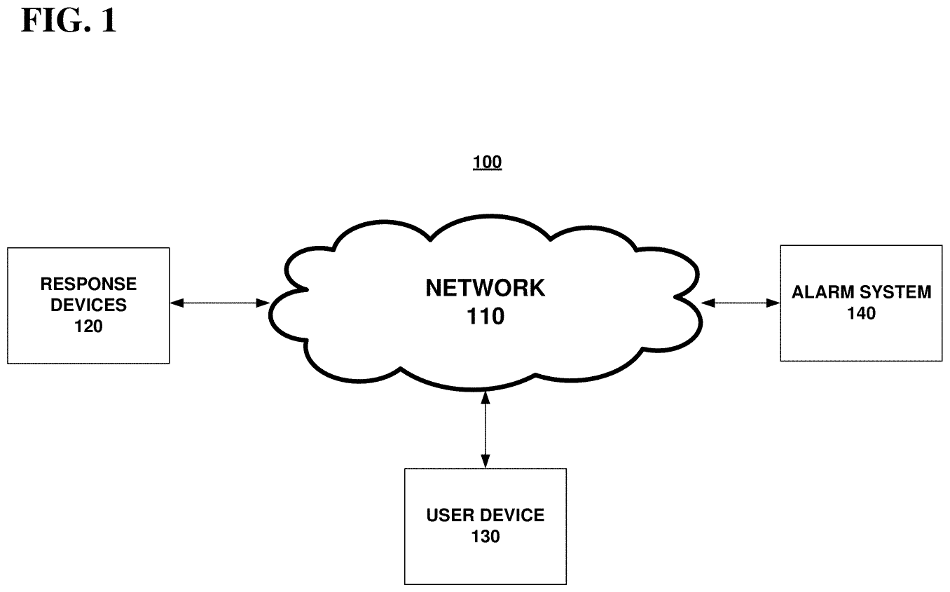

Turning now to FIG. 1, an exemplary environment that facilitates an alarm system response according to an embodiment is provided. As illustrated, environment 100 includes a coupling of response devices 120, user device 130, and alarm system 140 via network 110 (e.g., the Internet, a radio frequency identification (RFID) network, a Bluetooth network, etc.). In an aspect disclosed herein, it is contemplated that alarm system 140 may be configured to monitor any of various threats to occupants of a building (e.g., a dwelling, office, factory, store, etc.) including, but not limited to, trespassers, fire, gas leaks, etc., wherein alarm system 140 may then be further configured to activate one or more of response devices 120 within the building upon detecting a threat. It is also contemplated that a computer application residing on user device 140 can be used to interact with response devices 120 and/or alarm system 140 (e.g., to configure settings, monitor threats, etc.), wherein user device 130 can be any type of computing device (e.g., a mobile phone, tablet, laptop, desktop computer, etc.).

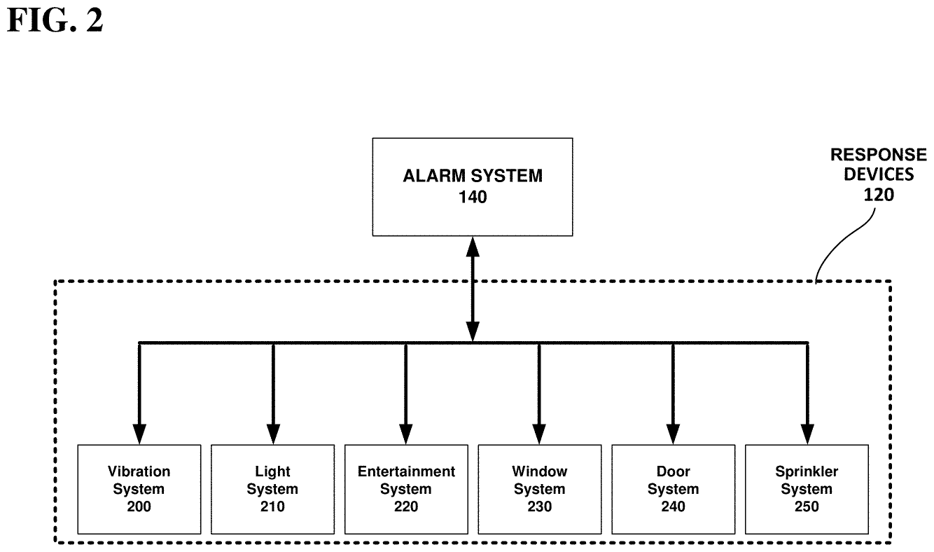

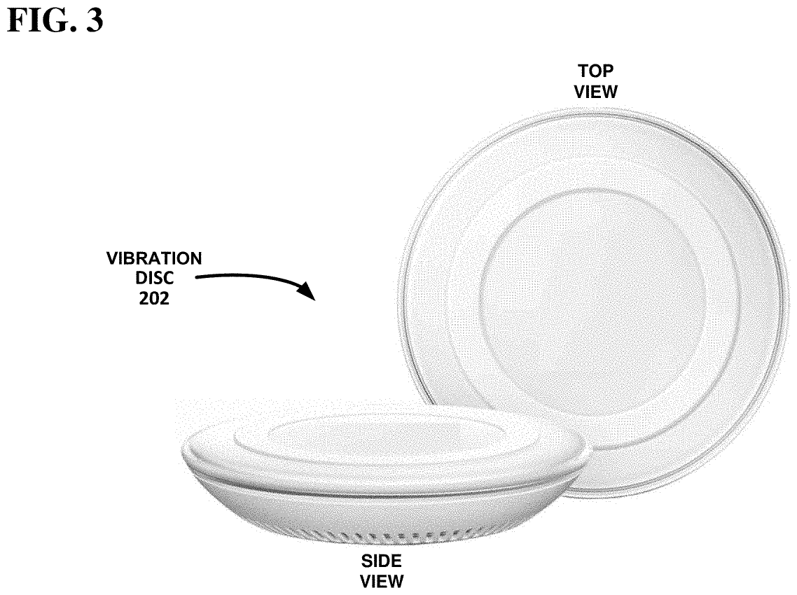

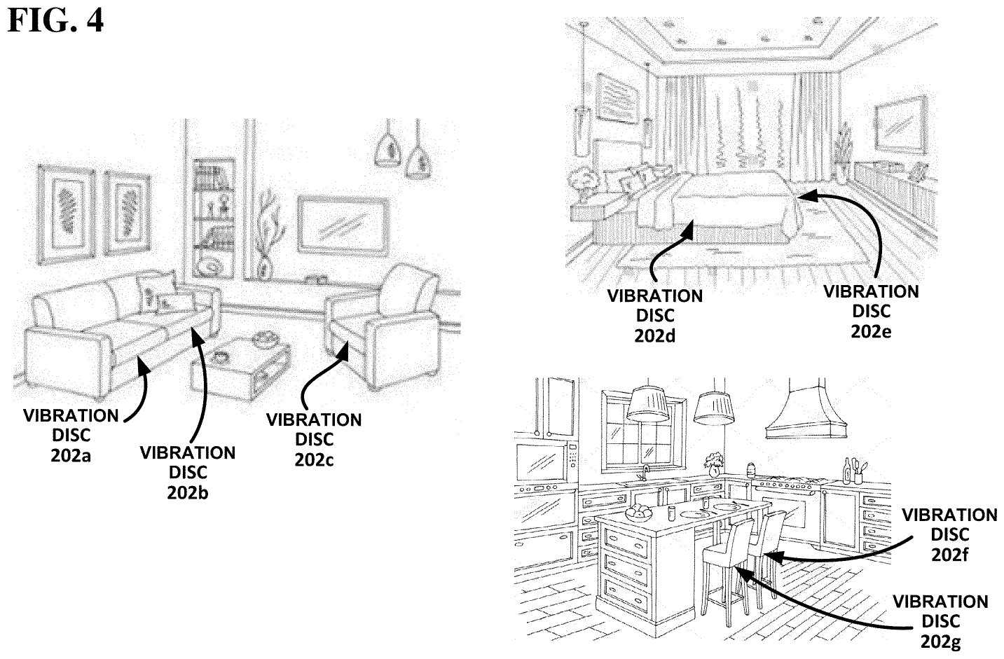

Referring next to FIG. 2, a block diagram is provided illustrating exemplary response devices coupled to an alarm system in accordance with aspects disclosed herein. As illustrated, it is contemplated that alarm system 140 may be configured to communicate with any of a plurality of response devices 120. For instance, alarm system 140 may be configured to control any of a plurality of alert-related devices such as vibration system 200 (e.g., where an occupant is alerted via aspects described with respect to FIGS. 3-4), light system 210 (e.g., where an occupant is alerted by strobing interior/exterior lights of the building), and/or entertainment system 220 (e.g., where an occupant is alerted via a speaker system).

In addition to alerting occupants of a potential threat, it should be appreciated that alarm system 140 may be configured to provide occupants with guidance during an emergency. For instance, alarm system 140 may be configured to grant emergency personnel remote control of entertainment system 220. Within such embodiment, entertainment system 220 may include an array of speakers, cameras, and microphones throughout the building, for example, wherein emergency personnel can utilize entertainment system 220 to monitor the situation and/or communicate directly with occupants of the building.

In another aspect disclosed herein, alarm system 140 may be configured to control any of a plurality of mitigation-related devices such as window system 230, door system 240, and/or sprinkler system 250. Moreover, it is contemplated that upon detecting a particular threat, alarm system 140 may be configured to mitigate the threat via one or more of window system 230, door system 240, and/or sprinkler system 250. Upon detecting a fire, for example, alarm system 140 may be configured to automatically provide ventilation by opening windows of window system 230 and doors of door system 240. Alarm system 140 may also be configured to automatically activate sprinkler system 250. For a different type of threat (e.g., a gas leak), alarm system 140 may be configured to automatically activate a different subset of systems (e.g., by automatically shutting off the gas; providing ventilation via window system 230 and door system 240; but not activating sprinkler system 250).

Alternatively, rather than automatically activating particular systems, emergency personnel may again be granted remote control of alarm system 140, wherein emergency personnel may activate systems, as appropriate. If a gas leak is detected, for example, emergency personnel can utilize entertainment system 220 to monitor the situation and provide ventilation via window system 230 and/or door system 240, as appropriate. Emergency personnel can also shut off the gas remotely by sending a shut off command either directly to the building (e.g., where a shut off valve is configured to receive remote commands via network 110, for example) or to the gas company.

Referring next to FIGS. 3-4, an exemplary implementation of vibration system 200 is provided, wherein vibration system 200 includes an array of discs configured to vibrate when alarm system 140 detects a threat. An exemplary vibration disc 202 is provided in FIG. 3 in which the dimensions of vibration disc 202 may include a diameter of approximately 4 inches and a thickness of approximately 0.5 inches, for example. Here, it should be appreciated that vibration disc 202 may be powered via a conventional wall outlet and/or batteries, wherein a particular embodiment of vibration disc 202 is powered by less than 22 watts. It should be further appreciated that vibration disc 202 may be configured to communicate with alarm system 140 via either a wired connection or a wireless protocol. In an alternative embodiment, rather than an array of discs, vibration system 200 may comprise a device worn by the occupants of a house/building (e.g., a mini-disc worn as a necklace).

FIG. 4 illustrates a home equipped with an exemplary array of vibration discs 202a-202g in accordance with an aspect of the subject specification. As illustrated, it is contemplated that vibration discs 202a-202g can be placed virtually anywhere in a home, but preferably wherever an occupant is likely to feel a vibration from vibration discs 202a-202g. For instance, in this particular example, vibration discs 202a-202c are placed beneath the seat cushions of a couch in a living room. Since an occupant may be asleep when alarm system 140 gets triggered, vibration discs 202d-202e may also be placed beneath the mattress of a bed, as shown. In this example, vibration discs 202f-202g are also placed beneath chairs in a kitchen.

During use, whenever alarm system 140 is triggered, it is contemplated that each of vibration discs 202a-202g will begin to vibrate so as to alert occupants of a corresponding emergency. In an aspect disclosed herein, it is further contemplated that vibration discs 202a-202g may be configured to continue vibrating until a user deactivates alarm system 140 by entering their credentials (e.g., via user device 130).

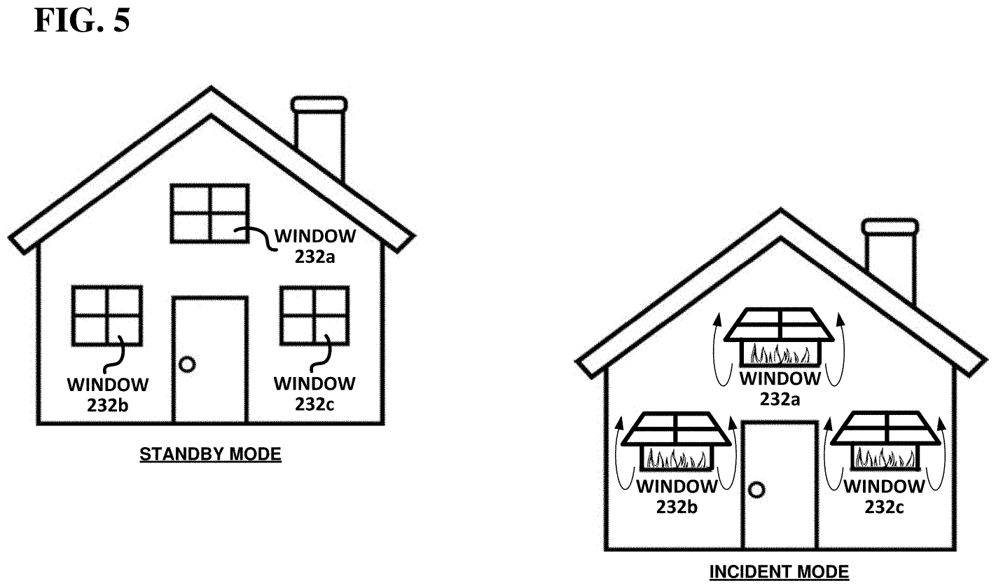

Referring next to FIG. 5, an exemplary implementation of window system 230 is provided, wherein window system 230 includes an array of powered windows configured to open when alarm system 140 detects a ventilation-related threat. For instance, in the example illustrated in FIG. 5 the ventilation-related threat is from a fire, wherein the array of powered windows 232a-232c are configured to open automatically in response to alarm system 140 detecting the fire.

Here, it should be appreciated that powered windows 232a-232c may be configured to open in any of a plurality of ways. For instance, a motorized crank mechanism may be used to open powered windows 232a-232c in an outward direction, as shown. Alternatively, a motorized piston mechanism may be used as well. It should be further appreciated that, although powered windows 232a-232c are shown as opening in an outward direction, the aforementioned motorized mechanisms can be used to open windows that slide open laterally.

In another aspect, it is noted that the various embodiments described above for window system 230 are similarly contemplated for door system 240. Moreover, whenever a ventilation-related threat is detected by alarm system 140 (e.g., fire, carbon monoxide, natural gas leak, etc.), it is contemplated that one or more windows of window system 230 and/or one or more doors of door system 240 may be configured to open automatically so as to mitigate the detected threat by providing a desired ventilation. Here, it should be noted that doors included in door system 240 can be any type of door including, but not limited to garage doors, sliding doors, etc.

It should be noted that the aforementioned embodiments contemplated for window system 230 and door system 240 are desirable for several reasons. For instance, when firefighters arrive at a burning house/building, it is common for them to begin by creating ventilation. Such a task often requires the destroying of property (e.g., breaking windows, making holes in the roof, etc.), which can be avoided via the automatic ventilation system disclosed herein. More importantly, rather than having to spend time ventilating a burning house/building themselves, firefighters can immediately focus on life-saving tasks upon arrival instead. Also, by automatically opening windows and doors during a fire, window system 230 and door system 240 desirably provide escape routes for occupants and entry points for firefighters.

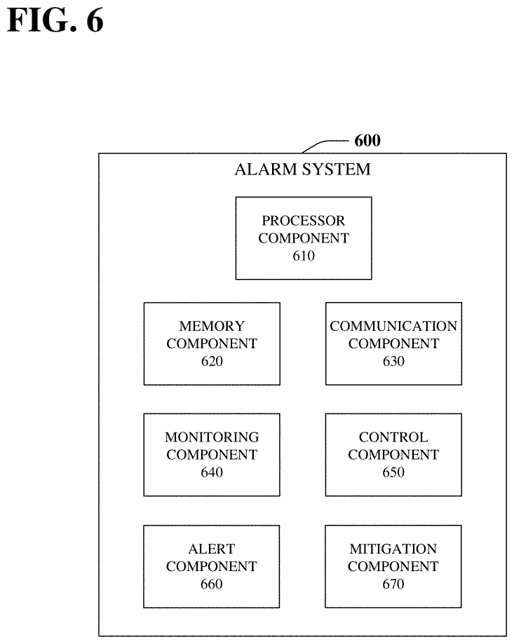

Referring next to FIG. 6, a block diagram of an exemplary alarm system is provided, wherein it is contemplated that alarm system 600 is substantially similar to alarm system 140. As illustrated, alarm system 600 may include a processor component 610, a memory component 620, a communication component 630, a monitoring component 640, a control component 650, an alert component 660 (e.g., any of vibration system 200, light system 210, and/or entertainment system 220), and a mitigation component 670 (e.g., any of window system 230, door system 240, and/or sprinkler system 250). Components 610-670 may reside together in a single location or separately in different locations in various combinations, including, for example, a configuration in which at least one of the aforementioned components reside in a cloud.

In one aspect, processor component 610 is configured to execute computer-readable instructions related to performing any of a plurality of functions. Processor component 610 can be a single processor or a plurality of processors which analyze and/or generate information utilized by memory component 620, communication component 630, monitoring component 640, control component 650, alert component 660, and/or mitigation component 670. Additionally or alternatively, processor component 610 may be configured to control one or more components of alarm system 600.

In another aspect, memory component 620 is coupled to processor component 610 and configured to store computer-readable instructions executed by processor component 610. Memory component 620 may also be configured to store any of a plurality of other types of data including data generated by any of communication component 630, monitoring component 640, control component 650, alert component 660, and/or mitigation component 670. Memory component 620 may be configured to store any of several types of information explained above, including preferred user settings/configurations of alarm system 600, for example.

Memory component 620 can be configured in a number of different configurations, including as random access memory, battery-backed memory, Solid State memory, hard disk, magnetic tape, etc. Various features can also be implemented upon memory component 620, such as compression and automatic back up (e.g., use of a Redundant Array of Independent Drives configuration). In one aspect, the memory may be located on a network, such as a “cloud storage” solution.

Communication component 630 may be used to interface alarm system 600 with external entities. For example, communication component 630 may be configured to receive and/or transmit data via a wireless network (See e.g., FIG. 1) and/or a wired network. In a particular embodiment, communication component 630 may be configured to interface with a user via a computer application (e.g., a computer application residing on user device 130), wherein a “user” is loosely defined so as to include an occupant of a building monitored by alarm system 600 (e.g., a home owner) and/or someone associated with a building monitored by alarm system 600 (e.g., a family member associated with the occupant(s) of a house).

In another aspect disclosed herein, it is contemplated that communication component 630 may be configured to enable external entities to control any of a plurality of systems coupled to alarm system 600. For instance, communication component 630 may be coupled to alert component 660 so as to enable external entities to alert and/or communicate with occupants of a house in response to a triggering of alarm system 600 (e.g., where emergency responders may control any of vibration system 200, light system 210, and/or entertainment system 220). Similarly, communication component 630 may be coupled to mitigation component 670 so as to enable external entities to mitigate an incident detected by alarm system 600 (e.g., where emergency responders may control any of window system 230, door system 240, and/or sprinkler system 250).

In a particular implementation of alarm system 600, it is contemplated that monitoring component 640 is configured to detect a danger in a dwelling, and that alert component 660 comprises an array of vibration devices placed throughout a dwelling (e.g., vibration discs 202a-202g), wherein each of the array of vibration devices are configured to provide a tactile alert in response to monitoring component 640 detecting a danger in the dwelling (e.g., fire/smoke, intruder, gas leak, etc.). Communication component 630 may then be configured to transmit a notification of the danger to an entity outside of the dwelling. As previously mentioned, such an entity can be any of a plurality of entities including, for example, law enforcement, a fire department, emergency medical services, and/or a mobile computer application.

Here, it should be noted that, monitoring component 640 may comprise a sensor configured to detect a trespassing danger (e.g., via motion sensors, glass break sensors, etc.), wherein each of the array of vibration devices are configured to provide the tactile alert in response to a detection of the trespassing danger. Similarly, monitoring component 640 may comprise a sensor configured to detect a ventilation-related danger (e.g., fire/smoke, toxic gas, flammable gas, etc.), wherein each of the array of vibration devices are configured to provide the tactile alert in response to a detection of the ventilation-related danger. For ventilation-related dangers, it is contemplated that mitigation component 670 may be configured to open at least one of a door or a window in the dwelling to mitigate the ventilation-related danger.

In another aspect, it is contemplated that control component 650 may be configured to provide an external entity (e.g., law enforcement, a fire department, emergency medical services, and/or a mobile computer application) with remote control access to at least one device in the dwelling. For instance, control component 650 may be configured to provide remote control access to a speaker system in the dwelling. Control component 650 may even be further configured to facilitate a communication from the external entity via the speaker system.

In another implementation of alarm system 600, it is contemplated that monitoring component 640 is configured to detect a ventilation-related danger in a building. Here, it should be appreciated that alarm system 600 may be configured to detect any of various types of ventilation-related dangers including, but not limited to, smoke from a fire, unsafe levels of a toxic gas (e.g., carbon monoxide), and/or unsafe levels of a flammable gas (e.g., natural gas). Within such embodiment, mitigation component 670 may then be configured to mitigate the ventilation-related danger by opening at least one of a door or a window in the building, wherein such opening may be automatic in response to the detection of a ventilation-related danger, or wherein such opening is performed manually by an external entity and facilitated by communication component 630 (e.g., where a fire department takes control of window system 230 and/or door system 240). For instance, control component 650 may be configured to provide an external entity with remote control access to at least one device in the building (e.g., speaker system, HVAC system, door system, window system, camera system sprinkler system, etc.).

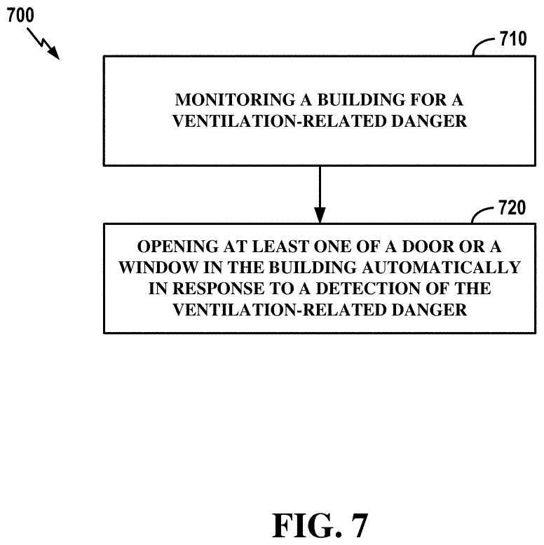

Referring next to FIG. 7, a first flow chart illustrating an exemplary method that facilitates an alarm system response according to an embodiment is provided. As illustrated, process 700 includes a series of acts that may be performed by an alarm system (e.g., alarm system 140 or 600) according to an aspect of the subject specification, wherein the series of acts may include any of the plurality of acts described with respect to alarm system 140 or 600. For instance, process 700 may be implemented by employing a processor to execute computer executable instructions stored on a computer readable storage medium to implement the series of acts. In another embodiment, a computer-readable storage medium comprising code for causing at least one computer to implement the acts of process 700 is contemplated.

As illustrated, process 700 may begin at act 710 with the monitoring of a building for a ventilation-related danger (e.g., fire/smoke, toxic gas, flammable gas, etc.). At act 720, process 700 then concludes with the opening of at least one of a door or a window in the building automatically in response to a detection of the ventilation-related danger.

Various other aspects of process 700 are also contemplated. For instance, process 700 may further comprise broadcasting an alert about the ventilation-related danger via a computer application automatically in response to a detection of the ventilation-related danger (e.g., where the danger is broadcast to all commercial/residential tenants of a building that is on fire). Process 700 may also comprise alerting an external entity about the ventilation-related danger automatically in response to a detection of the ventilation-related danger. Within such embodiment, process 700 may further comprise providing the external entity with remote control access to at least one device in the building (e.g., speaker system, HVAC system, door system, window system, camera system sprinkler system, etc.).

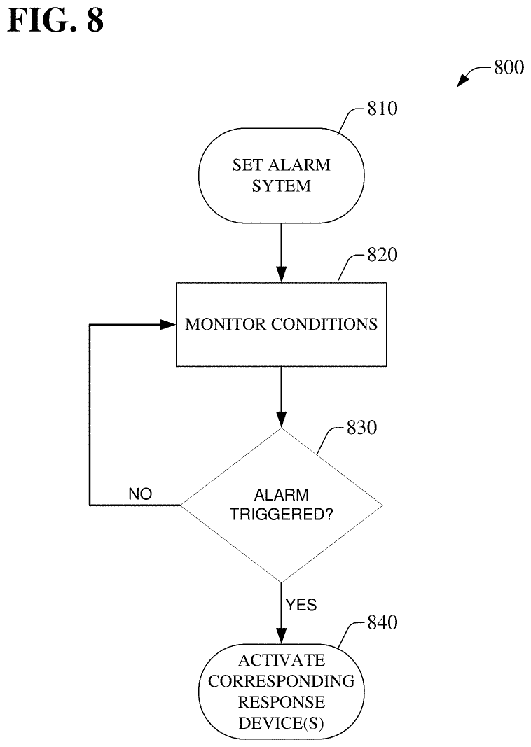

Referring next to FIG. 8, a second flow chart illustrating an exemplary method that facilitates an alarm system response according to an embodiment is provided. As illustrated, process 800 includes a series of acts that may be performed by an alarm system (e.g., alarm system 140 or 600) according to an aspect of the subject specification, wherein the series of acts may include any of the plurality of acts described with respect to alarm system 140 or 600. For instance, process 800 may be implemented by employing a processor to execute computer executable instructions stored on a computer readable storage medium to implement the series of acts. In another embodiment, a computer-readable storage medium comprising code for causing at least one computer to implement the acts of process 800 is contemplated.

As illustrated, process 800 may begin at act 810 with the activation of alarm system 600 in which such activation can be made via a wireless communication protocol (e.g., with a user device 130 via network 110) and/or a wired connection. At act 820, alarm system 600 then begins to monitor a building for any of a plurality of threats via any of a plurality of sensors, cameras, etc. configured to detect such threats. A determination of whether a threat has indeed been detected is then reached at act 830. If a threat has not been detected, then process 800 loops back to act 820 where conditions continue to be monitored. Otherwise, if a threat has been detected, process 800 concludes at act 840 where at least one corresponding response device is activated (e.g., any of response devices 120 including, but not limited to, vibration system 200, light system 210, entertainment system 220 window system 230, door system 240, and/or sprinkler system 250).

### Exemplary Networked and Distributed Environments

One of ordinary skill in the art can appreciate that various embodiments for implementing the use of a computing device and related embodiments described herein can be implemented in connection with any computer or other client or server device, which can be deployed as part of a computer network or in a distributed computing environment, and can be connected to any kind of data store. Moreover, one of ordinary skill in the art will appreciate that such embodiments can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

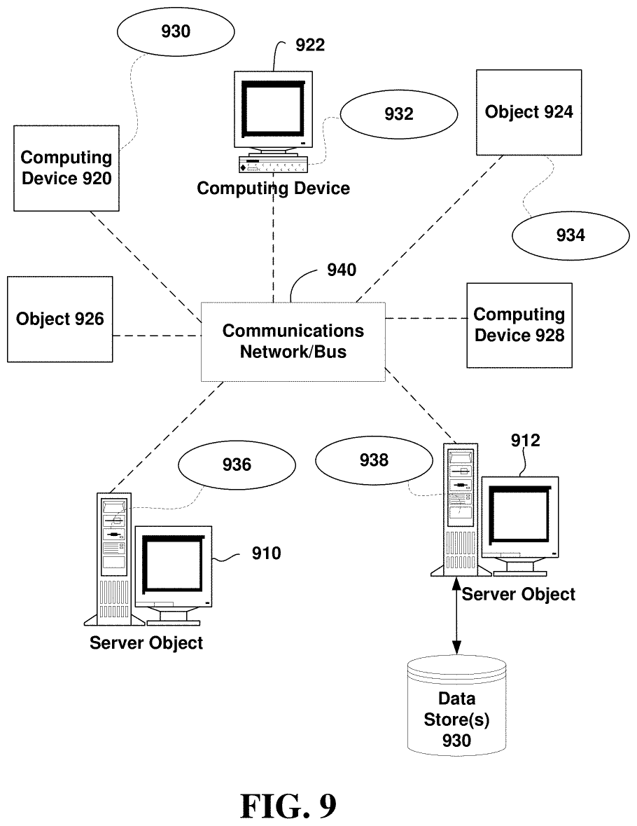

FIG. 9 provides a non-limiting schematic diagram of an exemplary networked or distributed computing environment. The distributed computing environment comprises computing objects or devices 910, 912, etc. and computing objects or devices 920, 922, 924, 926, 928, etc., which may include programs, methods, data stores, programmable logic, etc., as represented by applications 930, 932, 934, 936, 938. It can be appreciated that computing objects or devices 910, 912, etc. and computing objects or devices 920, 922, 924, 926, 928, etc. may comprise different devices, such as PDAs (personal digital assistants), audio/video devices, mobile phones, MP3 players, laptops, etc.

Each computing object or device 910, 912, etc. and computing objects or devices 920, 922, 924, 926, 928, etc. can communicate with one or more other computing objects or devices 910, 912, etc. and computing objects or devices 920, 922, 924, 926, 928, etc. by way of the communications network 940, either directly or indirectly. Even though illustrated as a single element in FIG. 9, network 940 may comprise other computing objects and computing devices that provide services to the system of FIG. 9, and/or may represent multiple interconnected networks, which are not shown. Each computing object or device 910, 912, etc. or 920, 922, 924, 926, 928, etc. can also contain an application, such as applications 930, 932, 934, 936, 938, that might make use of an API (application programming interface), or other object, software, firmware and/or hardware, suitable for communication with or implementation of the disclosed aspects in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 9, as a non-limiting example, computing objects or devices 920, 922, 924, 926, 928, etc. can be thought of as clients and computing objects or devices 910, 912, etc. can be thought of as servers where computing objects or devices 910, 912, etc. provide data services, such as receiving data from computing objects or devices 920, 922, 924, 926, 928, etc., storing of data, processing of data, transmitting data to computing objects or devices 920, 922, 924, 926, 928, etc., although any computer can be considered a client, a server, or both, depending on the circumstances. Any of these computing devices may be processing data, or requesting services or tasks that may implicate aspects and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 940 is the Internet, for example, the computing objects or devices 910, 912, etc. can be Web servers with which the computing objects or devices 920, 922, 924, 926, 928, etc. communicate via any of a number of known protocols, such as HTTP. As mentioned, computing objects or devices 910, 912, etc. may also serve as computing objects or devices 920, 922, 924, 926, 928, etc., or vice versa, as may be characteristic of a distributed computing environment.

### Exemplary Computing Device

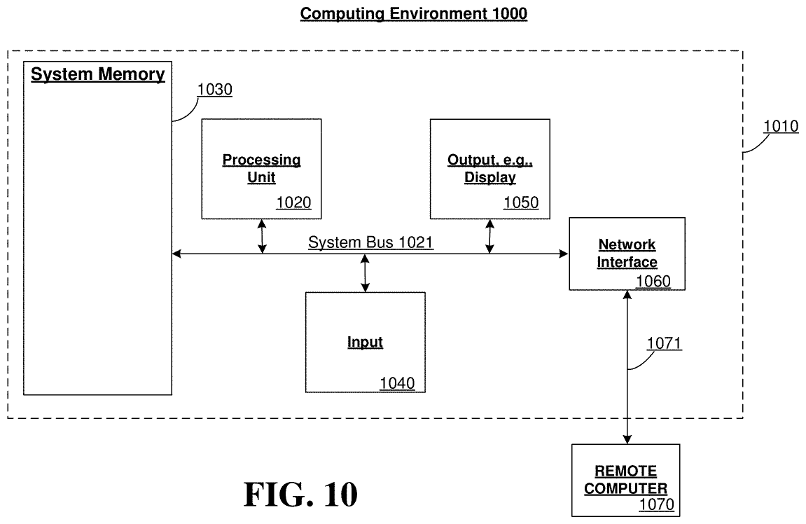

As mentioned, several of the aforementioned embodiments apply to any device wherein it may be desirable to include a computing device to facilitate implementing the aspects disclosed herein. It is understood, therefore, that handheld, portable and other computing devices and computing objects of all kinds are contemplated for use in connection with the various embodiments described herein. Accordingly, the below general purpose remote computer described below in FIG. 10 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer executable instructions, such as program modules, being executed by one or more computers, such as client workstations, servers or other devices. Those skilled in the art will appreciate that network interactions may be practiced with a variety of computer system configurations and protocols.

FIG. 10 thus illustrates an example of a suitable computing system environment 1000 in which one or more of the embodiments may be implemented, although as made clear above, the computing system environment 1000 is only one example of a suitable computing environment and is not intended to suggest any limitation as to the scope of use or functionality of any of the embodiments. The computing environment 1000 is not to be interpreted as having any dependency or requirement relating to any one or combination of components illustrated in the exemplary operating environment 1000.

With reference to FIG. 10, an exemplary remote device for implementing one or more embodiments herein can include a general purpose computing device in the form of a handheld computer 1010. Components of handheld computer 1010 may include, but are not limited to, a processing unit 1020, a system memory 1030, and a system bus 1021 that couples various system components including the system memory to the processing unit 1020.

Computer 1010 typically includes a variety of computer readable media and can be any available media that can be accessed by computer 1010. The system memory 1030 may include computer storage media in the form of volatile and/or nonvolatile memory such as read only memory (ROM) and/or random access memory (RAM). By way of example, and not limitation, memory 1030 may also include an operating system, application programs, other program modules, and program data.

A user may enter commands and information into the computer 1010 through input devices 1040 A monitor or other type of display device is also connected to the system bus 1021 via an interface, such as output interface 1050. In addition to a monitor, computers may also include other peripheral output devices such as speakers and a printer, which may be connected through output interface 1050.

The computer 1010 may operate in a networked or distributed environment using logical connections to one or more other remote computers, such as remote computer 1070. The remote computer 1070 may be a personal computer, a server, a router, a network PC, a peer device or other common network node, or any other remote media consumption or transmission device, and may include any or all of the elements described above relative to the computer 1010. The logical connections depicted in FIG. 10 include a network 1071, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and advertising architectures, the underlying concepts may be applied to any network system and any computing device or system in which it is desirable to implement the aspects disclosed herein.

There are multiple ways of implementing one or more of the embodiments described herein, e.g., an appropriate API, tool kit, driver code, operating system, control, standalone or downloadable software object, etc. which enables applications to implement the aspects disclosed herein. Embodiments may be contemplated from the standpoint of an API (or other software object), as well as from a software or hardware object that facilitates implementing the aspects disclosed herein in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter can be appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While in some embodiments, a client side perspective is illustrated, it is to be understood for the avoidance of doubt that a corresponding server perspective exists, or vice versa. Similarly, where a method is practiced, a corresponding device can be provided having storage and at least one processor configured to practice that method via one or more components.

While the various embodiments have been described in connection with the preferred embodiments of the various figures, it is to be understood that other similar embodiments may be used or modifications and additions may be made to the described embodiment for performing the same function without deviating there from. Still further, one or more aspects of the above described embodiments may be implemented in or across a plurality of processing chips or devices, and storage may similarly be affected across a plurality of devices. Therefore, the present invention should not be limited to any single embodiment.

What is claimed is:

1. An alarm system, comprising:
a monitoring component configured to detect a danger in a dwelling; and
an alert component comprising an array of vibration devices placed throughout the dwelling, wherein each of the array of vibration devices are configured to provide a tactile alert in response to a detection of the danger in the dwelling.

2. The alarm system of claim 1, wherein the monitoring component comprises a sensor configured to detect a trespassing danger, and wherein each of the array of vibration devices are configured to provide the tactile alert in response to a detection of the trespassing danger.

3. The alarm system of claim 1, wherein the monitoring component comprises a sensor configured to detect a ventilation-related danger, and wherein each of the array of vibration devices are configured to provide the tactile alert in response to a detection of the ventilation-related danger.

4. The alarm system of claim 3, further comprising a mitigation component configured to open at least one of a door or a window in the dwelling to mitigate the ventilation-related danger.

5. The alarm system of claim 1, further comprising a control component configured to provide an external entity with remote control access to at least one device in the dwelling.

6. The alarm system of claim 5, wherein the control component is configured to provide remote control access to a speaker system in the dwelling.

7. The alarm system of claim 6, wherein the control component is configured to facilitate a communication from the external entity via the speaker system.

8. An alarm system, comprising:
a monitoring component configured to detect a ventilation-related danger in a building; and
a mitigation component configured to open at least one of a door or a window in the building automatically in response to a detection of the ventilation-related danger.

9. The alarm system of claim 8, further comprising an alert component configured to provide an alert associated with the ventilation-related danger.

10. The alarm system of claim 9, wherein the alert component is configured to disseminate the alert via a computer application.

11. The alarm system of claim 8, further comprising a control component configured to provide an external entity with remote control access to at least one device in the building.

12. The alarm system of claim 11, wherein the control component is configured to provide remote control access to a camera system in the building.

13. The alarm system of claim 11, wherein the control component is configured to provide remote control access to a sprinkler system in the building.

14. A method comprising:
monitoring a building for a ventilation-related danger; and
opening at least one of a door or a window in the building automatically in response to a detection of the ventilation-related danger.

15. The method of claim 14, wherein the ventilation-related danger is at least one of a fire, toxic gas, or flammable gas.

16. The method of claim 14, further comprising broadcasting an alert about the ventilation-related danger via a computer application automatically in response to a detection of the ventilation-related danger.

17. The method of claim 14, further comprising alerting an external entity about the ventilation-related danger automatically in response to a detection of the ventilation-related danger.

18. The method of claim 17, further comprising providing the external entity with remote control access to at least one device in the building.

19. The method of claim 18, wherein the providing comprises providing the external entity with remote control access to a heating, ventilation and air conditioning (HVAC) system in the building.

20. The method of claim 18, wherein the providing comprises providing the external entity with remote control access to a speaker system in the building.
